(19) United States
(12) Patent Application Publication
(10) Pub. No.: US 2016/0267419 A1
(43) Pub. Date: Sep. 15, 2016

(54) Simple and integrated method and system for business process definition, planning and execution

(71) Applicant: Kothandaraman Rajendran, Chatsworth, CA (US)

(72) Inventor: Kothandaraman Rajendran, Chatsworth, CA (US)

(73) Assignee: SIMBYM, Chatsworth, CA (US)

(21) Appl. No.: 14/642,424

(22) Filed: Mar. 9, 2015

(51) Int. Cl. G06Q 10/06

(52) U.S. Cl. CPC G06Q 10/06316

(57) ABSTRACT

A process is limited to 3 levels of hierarchy to simplify the definition, planning and execution of processes. The method provides for pre-configured process templates using three levels as process stages, business or IT services and deliverables defined as documents, data sets and task list to complete the deliverables. Different owners can be assigned to each level and deliverable, thereby distributing the ownership for simplified execution.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND

1. Technical Field

The present invention relates to a simple and integrated method and system that simplifies the execution of business processes in computing devices by defining a configurable process with three levels of process hierarchy with ownership defined while providing the flexibility to complete the process and improve efficiency and effectiveness.

2. History of Related Art

Enterprises require their business processes, like Technology Project Management, to be planned and executed efficiently and effectively. Standards and Processes have been established by organizations such as the Project Management Institute (PMI) and the Information Systems Audit and Control Association (ISACA). While these standards are comprehensive, they require interpretation of the actual implementation of the methodologies. Management of processes as projects usually suffers due to complexity of the projects, a lack of guidance on how to implement the methodologies across an organization and lack of ownership within the process. Hence, implementation of processes as projects is very complex and neither effective nor efficient.

There is a need within the art for a simple and integrated method and system using computing devices to perform business processes.

### 3. REFERENCES CITED

U.S. Patent Documents

| | | | | |
|---|---|---|---|---|
| 8,407,078 | B1 | March 2013 | Caputo et al. | 705/7.27 |
| 8,818,993 | B2 | August 2014 | Boyd et al | 707/722 |
| 8,812,340 | B2 | August 2014 | Facciorusso et al. | 705/7.27 |
| 8,694,487 | B2 | April 2014 | Lamothe | 707/720 |

### SUMMARY OF THE INVENTION

In one embodiment, a simple and integrated method and system to define and execute business processes as a project includes implementing software that can be executed on a plurality of computing devices and computer servers for executing business processes in an enterprise. The method of simplifying and integrating business processes as a project includes a configurable pre-defined plurality of business processes that can be executed as a project with a defined project manager as an owner. Each business process can be defined as a plurality of stages with the project manager assigned as owner. Each stage can further be defined as a plurality of pre-defined business or technology services that are designated as being impacted by the particular embodiment of the business process and assigned a pre-defined owner of the service who can be changed for this embodiment of the process. Each impacted service can be defined as a plurality of required or optional documents for the stage; and/or a plurality of other documents deemed necessary for collaboration in completing the requirements of the phase; and/or a plurality of pre-defined or configurable discrete data sets presented with a user interface for data capture; and/or a plurality of tasks added to the specific instance or the service to be performed for the stage. The simplified and integrated method limits the process to three levels 1) Process Stages 2) Business and Technology Services and 3) Deliverables with different owners at each level.

In one embodiment, the simplified and integrated method and system also provides methods to 1) manage the embodiments of the process as a project, 2) manage the embodiments of services across projects 3) manage the embodiments of deliverables across projects.

In some embodiments, the simplified and integrated method and system assigns a predefined owner for each of item in each level based on pre-defined criteria that can be changed for the specific instance of the process being executed.

In one embodiment, the simplified and integrated method and system permits the assignment of a plurality of resources, from a pre-defined team of resources assigned to support the service, to perform tasks at the service level with a capability to change the owner and assignee at the deliverables level.

### BRIEF DESCRIPTION OF THE DRAWINGS

FIG. 1 is a diagram illustrating a networked environment where a system of embodiments may be implemented.

FIG. 2 illustrates a 3 level tree structure

FIG. 3 illustrates a logic flow diagram for setting up a process as a project for an embodiment.

### DETAILED DESCRIPTION

The simple and integrated method and system enables the definition of processes that can be used during the execution of the process as a project. The method may be implemented in a plurality of computer servers. The process information may be retrieved from the server and used to set up projects in order to plan, execute and track the completion of the process as a project. In the detailed descriptions references are made to the accompanying drawings which are shown as an illustration of specific embodiments or examples. Embodiments may combine these illustrations and use other aspects without departing from the spirit and scope of the invention described. The detailed description is not to be taken in a limiting sense but taken in the spirit and intent with which it is defined. The embodiments shown in the drawings are described in a general context as services that execute on computing devices and may be implemented differently in different embodiments.

Embodiments have to be implemented within a computing environment with computer systems, computer network and data and document storage devices either within the same enterprise or across enterprises connect by the internet or other network connections.

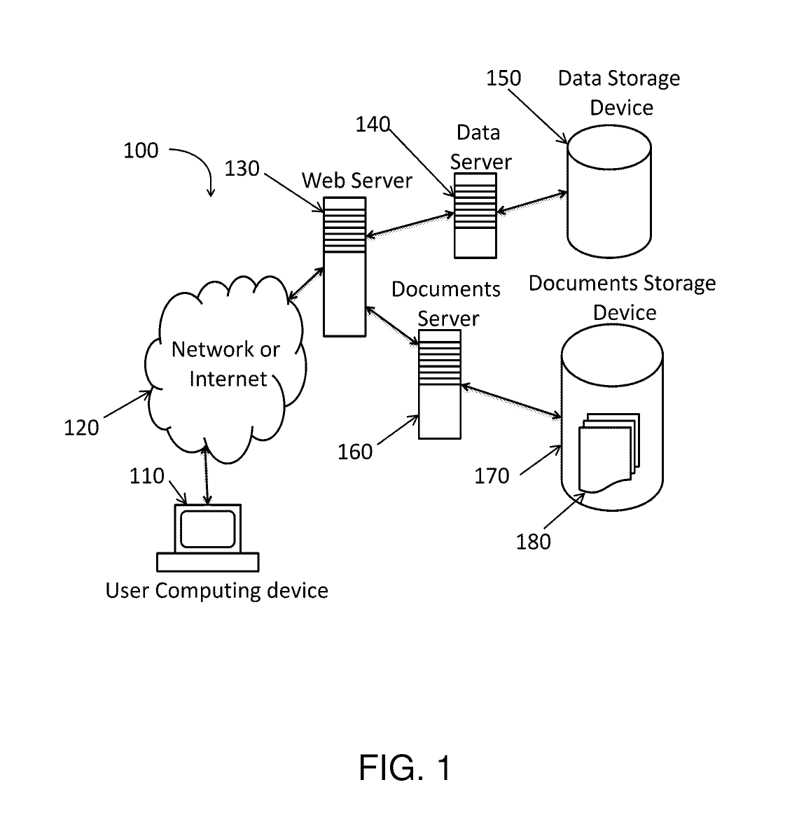

FIG. 1 is a diagram illustrating an embodiment of the implementation within a networked computing environment. In diagram 100, the client computing device 110, which may be a client computer or hand held device, may execute a program within the browser software running on it that it retrieves from the Web Server 130 through a network 120. The network 120 may be a network internal to the enterprise using the system or may be an external internet based network. Network 120 may be wired or wireless. Network nodes may connect in a secured or unsecured manner. Network may be secured with a Virtual Private Network (VPN).

The web server 130 may use any communication protocol. In some embodiments it may use the Hyper Text Transfer Protocol (HTTP). The web server 130 may provide data capture screens, programs and services to execute data service processes to request, edit, save and update data to and from the Data Server 140. The web server 130 may also provide programs and services to execute document services to request, add and update documents to and from the Document Server 160. The data server 140 may store and retrieve data from a Data Storage Device 150. The document server may store and retrieve documents 180 from a Documents Storage Device 170. The web server 130, the data server 140, the document server 160 may be implemented on a single physical server or on separate physical servers or a plurality of separate physical servers or a plurality of servers each of which has all three servers implemented within it.

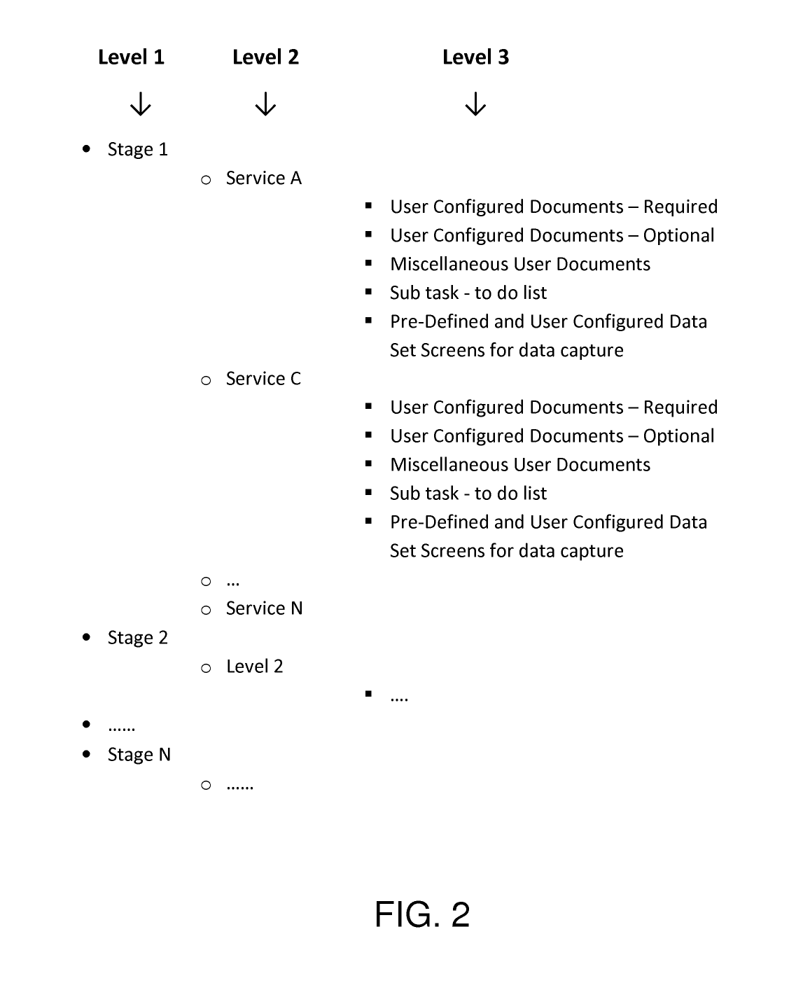

FIG. 2 illustrates a embodiment of process structure defined in 3 levels for a specific process type. In some embodiments a process type may be defined as a plurality of stages at a hierarchy of Level 1. Stages can be defined as setup data that may be configured by the user of the system and may include documents defined as required or optional for completing the stage and Pre-Defined and User Configured Data Set Screens for data captured for completing the stage An embodiment of the process type may be further defined in hierarchy Level 2 during the execution of that embodiment based on a plurality of services impacted by that embodiment. The services may be defined as setup data that may be configured by the user of the system and may include a service owner and a team defined to provide the service. Teams may contain resources that can perform tasks to complete the service. In some embodiments service definitions may include documents defined as required or optional for completing the service and Pre-Defined and User Configured Data Set Screens for data captured for completing the service. The execution of the service may be completed by producing the documents defined to complete the stage and the service as defined in the stage and service set up data; and the completion of data entry screens defined to complete the stage and service as defined in the stage and service setup data; and the completion of a set of sub tasks deemed necessary by the user and entered for the specific embodiment of the process; and the sharing of miscellaneous documents the user determines as needed to be shared for the completion of the service. This collection of documents, datasets and subtasks required to complete the service and stage are defined as hierarchy Level 3 of the process. The Level 3 hierarchy of the process may be assigned to an owner and may have resources assigned to complete the service. The owner at Level 3 may be different than the owner at Level 2. These 3 levels are the basis of the invention in providing a simple and integrated method and system for defining, planning and executing processes as projects with an owner at each level thereby distributing the management and ownership of the process. In some embodiments it can be described as a Distributed Project Management Methodology.

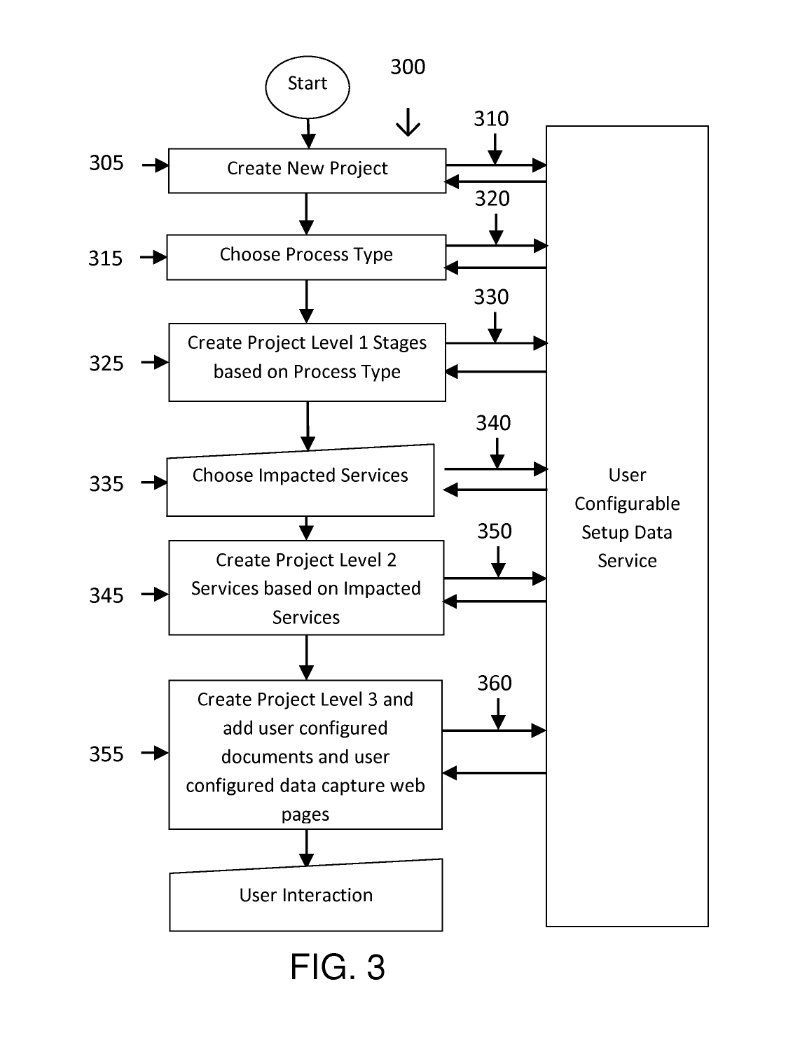

FIG. 3 illustrates a logic flow diagram 300 for setting up a process as a project for an embodiment. The operations shown in process 300 are used to create an embodiment of the process as a project. At operation 305 the user requests the creation of a new project. This initiates operation 310 to get access to set up data to add project information including but not limited the project manager assigned and process type available. At operation 315 a process type is chosen. Upon receiving the process type chosen the system initiates operation 320 that retrieves the plurality of stages for the specified process type. At operation 325 the system creates Level 1 project hierarchy as stages required to be completed and may assign an owner for each stage. In some embodiments additional data entry may be performed to add additional data to the stages. This information is sent to the server for storage of the data in operation 330. At operation 235 the user may choose a plurality of services impacted by this embodiment of the process. Upon receiving the impacted service data, the system retrieves 340 set up data for the impacted services and creates 345 the Level 2 hierarchy for the process and assigns the owner and team for the impacted services at Level 2. The system then retrieves 350 the configured data with respect to the documents and screens needed to complete the stage and service. At operation 355 the system creates the Level 3 hierarchy by adding the list of documents and data capture screens to the Level 3 hierarchy and assigns owners for each. The system also provides the screens needed to capture the user created tasks to complete the stage and service. The 3-level hierarchy data for this embodiment of the process stored and retrieved 360 to and from the data and document stores. Resources may be assigned to the services at Level 2 to execute the Level 3 to complete the process. The system also provides the capability to track the progress and completion of the deliverables. Embodiments of the method and system of 3-level hierarchy may be created to execute a plurality of processes as projects across the enterprise to simplify process executions.

The above specifications, examples and data provide a complete description of the implementation and use of the embodiments. The features and methods described above are examples of the implementation of the claims and embodiments. Even though the examples have been described in language specific to the structural features and methodological acts, the claims and embodiments should not be construed as limited to the specific features or acts described.

What is claimed is:

1. A method and system implemented and executed on computing devices and computer servers to simplify and integrate the definition, planning and execution of a plurality of business processes as projects by using and limiting the process to a 3-level hierarchy with a configurable and distributed ownership at each level with the implementation on computing devices and computer servers to manage the embodiments of the process as a project; manage the embodiments of services across projects; and manage the embodiments of deliverables across projects and comprising:
a configurable plurality of stages defined for each process type with the project manager as the owner for hierarchy level 1 of the process; and
a configurable plurality of business or technology services that may be marked as impacted during planning and execution of the process for each stage with a configurable owner and team of resources for each service as hierarchy level 2 of the process; and
a configurable plurality of documents that may be derived from pre-defined templates for each stage and/or service defined as required to be completed or left to the user discretion to be completed as hierarchy level 3 of the process; and
a configurable plurality of data entry screens for data sets for each stage and/or service to be completed as hierarchy level 3 of the process; and
a screen for user entered list of tasks at the time of execution of the process for each service as hierarchy level 3 of the process.
